(19) United States
(12) Patent Application Publication
(10) Pub. No.: US 2008/0041833 A1
(43) Pub. Date: Feb. 21, 2008

(54) Thermal tensioning during thermal edge finishing

(76) Inventors: Nicholas Dominic Cavallaro, Corning, NY (US); Zung-Sing Chang, Horseheads, NY (US); Gautam Narendra Kudva, Horseheads, NY (US); Weiwei Luo, Painted Post, NY (US); Ljerka Ukrainczyk, Painted Post, NY (US); Sam Sammer Zoubi, Horseheads, NY (US)

Correspondence Address: CORNING INCORPORATED, SP-TI-3-1, CORNING, NY, 14831, US

(21) Appl. No.: 11/507,294

(22) Filed: Aug. 21, 2006

(51) Int. Cl. B23K 26/00

(52) U.S. Cl. 219/121.85; 219/121.66; 264/482; 65/104

(57) ABSTRACT

A thermal edge-finishing process includes pre-heating an edge of a glass sheet, focused heating inboard of the edge to cause thermal tensioning, laser finishing the edge, and localized annealing of the edge. By stress cancellation, the thermal energy added by a laser edge-finishing operation does not result in as much residual stress. By the present process, residual stress is reduced to below 3000 psi, and more preferably to about 1000 psi, and as low as 600 psi in the first 1 mm along the treated edge.

### BACKGROUND OF THE INVENTION

1. Field of the Invention

The present application relates to thermal edge finishing of glass sheet, and more particularly relates to thermal tensioning of an edge of the glass sheet prior to laser finishing the edge and then annealing the edge after the laser finishing operation, the pre-laser and post-laser operations combining to reduce residual tensile stress along the edge.

2. Technical Background

At least one current finishing process for glass sheet for liquid crystal displays (LCDs) entails applying a coating for surface protection, mechanical cutting processes such as mechanical scoring with a score wheel and finishing processes such as grinding. These processes are historically wet processes and require washing of the glass sheet to eliminate contamination due to the glass chips produced during mechanical scoring and grinding processes. It is desirable to eliminate the need to wash the glass sheet during the edge-finishing process, and to eliminate related steps in the finishing process after the forming process.

Methods to clean cut glass sheet are known, such as by using a laser for glass scoring and separation, and/or by using a laser for cutting glass. For example, see Patent Nos. U.S. Pat. No. 6,713,730; U.S. Pat. No. 6,204,472; U.S. Pat. No. 6,327,875; U.S. Pat. No. 6,407,360; U.S. Pat. No. 6,420,678; U.S. Pat. No. 6,541,730 and U.S. Pat. No. 6,112,967. However, thermal processes (including the use of laser beams for glass scoring or glass cutting) generate high residual stresses in the glass since the glass is locally heated above its strain point during the processing. These stresses are undesirable as they can lead to breakage during subsequent handling, transport, and use. Further, they can prevent later cutting of the glass into smaller sizes. Radiant heaters can be used to reduce residual stresses via a localized heat treatment (annealing) process. However, the glass optical properties of glass limit the stress relief that can be obtained by radiant heaters.

It is known to use a laser to fire polish an edge of a glass disk that has already been chamfered using mechanical finishing techniques. For example, U.S. Pat. No. 6,521,862 discloses using a laser to smooth out surface scratches. However, the preferred beam of the '862 patent uses a 9.25 μm radiation to minimize depth of penetration for the laser beam because only surface finish is required. Notably, the '862 patent does not disclose using laser as a means to provide a rounded (chamfered) edge to a cut surface of glass, and it does not disclose how, or if, the residual stress is relieved. Further, the laser beam is focused to the edge and several passes of the laser beam are used, such that it is not conducive to use with a continuous glass-forming process.

WO 03015976 describes using an elliptical laser spot to chamfer a glass edge. However, the spot is placed on the corners of the edge at an angle, rather than orthogonal to the edge, and further the peak power of the spot is positioned directly on corners, such that the laser must pass along each edge (i.e., at least two passes are required). WO '976 further discloses that a second laser beam can be used for edge annealing, however the magnitude of the stress reduction is not reported. It is only reported that the edge does not crack due to chamfering. Notably, the chamfering method only rounds the corners of the edge and does not result in the edge being formed into a single full radius.

U.S. Pat. No. 4,682,003 describes using a laser to round the edge of laser cut glass. However, it does not disclose any method to relieve residual stress. Further, the edge is not fully rounded, but instead only corners are chamfered.

Therefore, the need exists for a clean edge-finishing process and apparatus for glass where the finished glass edge has reduced residual tensile stress along the edge.

### SUMMARY OF THE INVENTION

The present invention relates to clean finishing of a cut edge of brittle sheet, such as glass or ceramic sheet, with pre-laser and post-laser operations combining to reduce residual tensile stress along the edge(s). This is accomplished with relatively few edge-finishing steps and without the need for exotic processes or procedures in the edge-finishing process. The present system also provides for a repeatable and uniform process that is compatible with a continuous process for making glass sheet, such as for LCDs.

In one aspect of the present invention, a method of thermal edge finishing for finishing brittle sheet, such as glass and ceramic sheet, having at least one edge, comprises steps of heating at least one edge of the sheet including a strip of material that extends along the edge but inboard thereof. The method further includes increasing a temperature of the strip relative to a temperature at the edge, treating the edge with a thermal heat source such as a laser beam to round and finish the edge, and annealing the edge and the strip of material to reduce stresses generated during edge finishing.

In another aspect of the present invention, a method of thermal edge finishing for finishing an edge of sheet such as glass sheet and ceramic sheet, comprises steps of thermally tensioning the sheet along the edge by preheating the edge and also causing a temperature of an area located inboard from the edge to be higher than a temperature of the edge. The method further includes laser-finishing the edge to a non-sharp shape.

In still another aspect of the present invention, an apparatus for thermally finishing sheet such as glass sheet and ceramic sheet having an edge, includes a first heat source for heating the edge of the sheet including heating a strip of material that extends along the edge but inboard thereof. The apparatus further includes a second heat source for increasing a temperature of the strip relative to a temperature at the edge, a thermal heat source such as a laser device configured to produce a laser beam adapted to round and finish the edge, and a third heat source for annealing the edge and the strip of material to reduce stresses generated during edge finishing by the thermal heat source.

Additional features and advantages of the invention are set forth in the detailed description which follows, and in part will be readily apparent to those skilled in the art from that description or recognized by practicing the invention as described herein. For purposes of description, the following discussion is set forth in terms of glass manufacturing. However, it is understood the invention as defined and set forth in the appended claims is not so limited, except for those claims which specify the brittle material is glass.

It is to be understood that both the foregoing general description and the following detailed description are merely examples of the invention, and are intended to provide an overview or framework for understanding the nature and character of the invention as claimed below. Also, the above listed aspects of the invention, as well as the preferred and other embodiments of the invention discussed and claimed below, can be used separately or in any and all combinations.

The accompanying drawings are included to provide a further understanding of the invention, and are incorporated in and constitute a part of this specification. The drawings illustrate various embodiments of the invention, and together with the description serve to explain the principles and operation of the invention. It should be noted that the various features illustrated in the figures are not necessarily drawn to scale. In fact, the dimensions may be arbitrarily increased or decreased for clarity of discussion.

### BRIEF DESCRIPTION OF THE DRAWINGS

FIG. 1 is a process flow chart illustrating an edge-finishing process using thermal tensioning.

FIG. 2 is a schematic view showing a pre-heat process, and FIG. 2A illustrates thermal tensioning within the glass during the pre-heat process, the solid line representing a temperature profile at locations spaced inward from the edge surface.

FIG. 3 is a schematic view showing a focused pre-heat process for causing focused thermal tensioning of the edge immediately prior to the laser edge-finishing treatment, and FIG. 3A illustrates the resulting thermal tensioning within the glass immediately prior to the laser edge-finishing process, the solid line representing a temperature profile at locations spaced inward from the edge surface.

FIGS. 4, 4A, and 4B are perspective edge, and cross-sectional views of a glass sheet and laser beam shape and signature as used for edge finishing.

FIG. 5 is a schematic view showing a heater and burner configuration for localized heat treatment, and FIG. 5A illustrates the resulting localized heat treatment temperature profile at locations spaced inward from the edge surface.

FIGS. 6 and 6A are top and cross-sectional views of a glass sheet edge finished using the present process and apparatus.

### DETAILED DESCRIPTION OF PREFERRED EMBODIMENTS

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention can be practiced in other embodiments that depart from the specific details disclosed herein. Moreover, descriptions of well-known devices, methods and materials may be omitted so as not to obscure the description of the present invention.

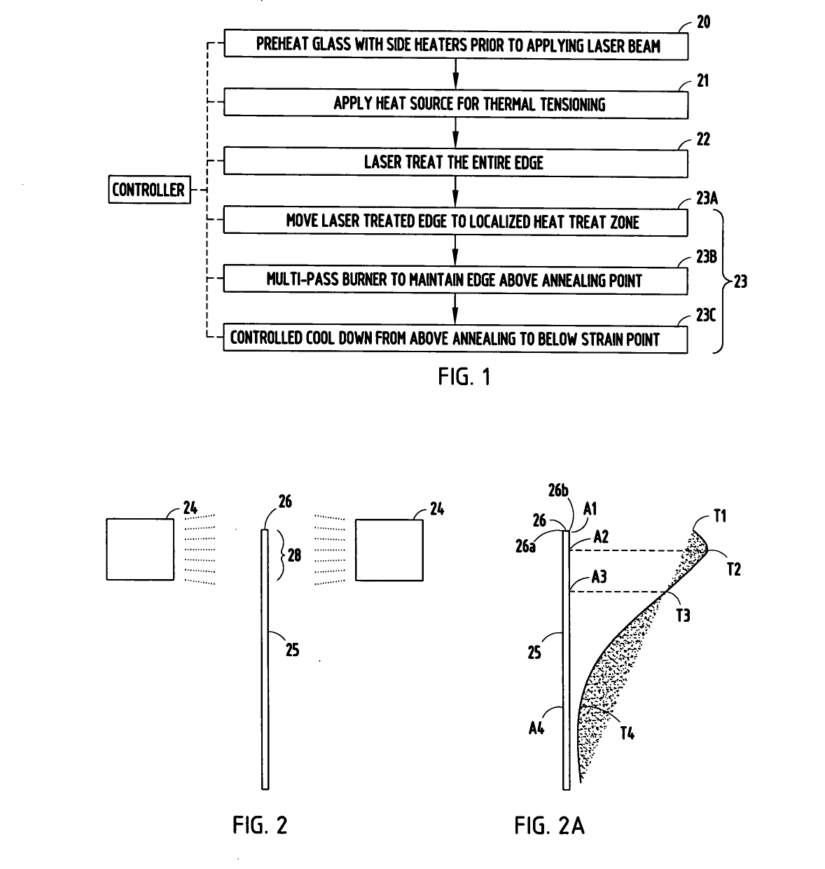

The illustrated process (FIG. 1) for thermal edge finishing includes four major steps: pre-heat (step 20), thermal tensioning along glass edge (step 21), laser edge finishing (step 22), and post-laser localized heat treatment/annealing (step 23). By raising a temperature of the glass inboard of the edge of the glass, the glass material along the edge is thermally tensioned. As a result, the thermal energy added by a laser edge-finishing operation does not result in as much residual stress along the edge in the finished glass sheet, as discussed below. This is important because there are limits to the amount of annealing that can be done to glass sheet while still maintaining its attributes such as shape and optical properties. By using the present process with thermal tensioning along an edge, the final glass sheet has lower edge stress, such as a residual stress of less than 1000 psi in the first 1 mm along the treated edge, as compared to a residual stress of about 8000 psi in the first 1 mm along the treated edge without using the present stress reducing process. Thus, undesired edge fracture during and post processing is reduced or eliminated. Also, the low edge stress maintains the ability to further cut the glass sheet at a later time with reduced risk of edge fracture, chipping, and unwanted glass cracking and breakage. The low edge stress also minimizes in-plane distortion, which may be important such as in a customer's assembly process.

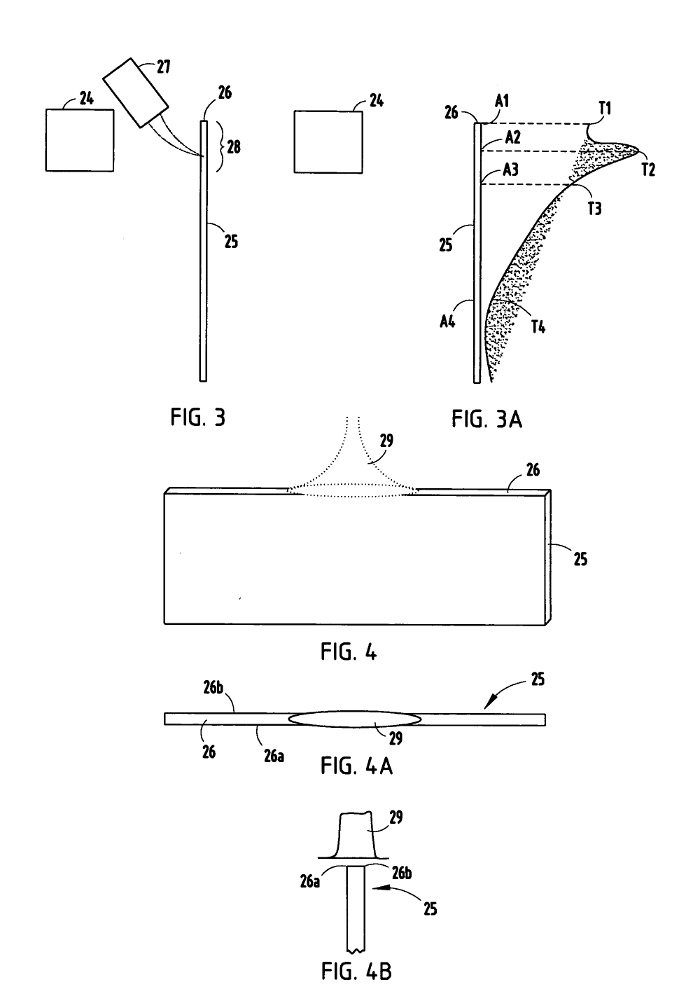

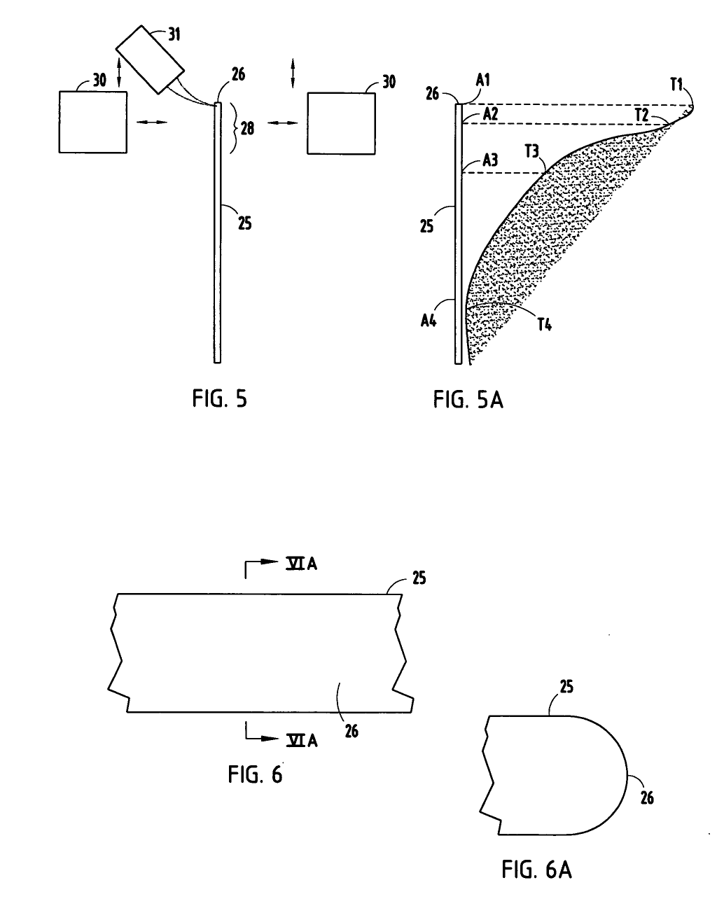

As illustrated in FIG. 2, the pre-heat step 20 uses opposing radiant heaters 24 (FIG. 2) to increase the temperature of the glass sheet 25 near the edge 26 to create a desired pattern of transient tension and compression which reduces residual stress along the edge in the cooled sheet. It is noted that the heaters 24 may not necessarily have to be at a same relative position to the glass and edge. The thermal tensioning step 21 includes focusing angled burners 27 (FIG. 3) (or alternatively, radiant heaters) to apply heat to a strip of material 28 spaced inward from the edge 26, thus causing the strip 28 to have a higher temperature than the edge 26 immediately prior to application of the laser beam 29, thereby resulting in thermal tensioning of the material along the edge. The laser edge-finishing step 22 (FIG. 4) includes applying the laser 29 to the edge 26 to round and finish the edge 26 (FIG. 6). The post-laser heat treatment/annealing step 23 (FIG. 5) includes using radiant heaters 30 and also using locally directed variable burner 31 to the edge 26 and strip 28 for localized heat treatment to reduce residual stress in the glass sheet 25. The illustrated step 23 includes a first step 23A (FIG. 1) of moving the glass sheet 25 with laser treated edge 26 to a localized heat treat area, a second step 23B of maintaining an edge temperature above an annealing point of the material along the edge, and a third step 23C of controlling cool down from above annealing temperature to below strain point.

A particular example will now be described. The illustrated glass sheet 25 is approximately 0.65 mm thick. (It is contemplated that the glass sheet can be of any thickness. Nonetheless, the present process is very well suited for use on thin glass such as a glass sheet having a thickness dimension of about 0.03 mm to 2.0 mm, for example.) The glass sheet 25 has at least one cut edge 26 with relatively sharp corners 26A and 26B (FIG. 2A) (i.e., “ends of the edge”). The present drawings show a single discretely-sized glass sheet shown as if it were held stationary during treatment, but it is contemplated that the glass sheet can be moved during processing as long as the glass sheet is accurately held in a known position. Alternatively, it is contemplated that the present process can be used in combination with a continuous process for forming glass sheet, such as along opposing trimmed edges or along a trimmed edge on a leading end (or trailing end) of the glass sheet. For example, the continuous process could operate at about 100 mm/sec line speed.

In step 20, the LCD glass sheet 25 (FIGS. 2 and 2A) is heated between opposing radiant heaters 24 located on opposite sides of the glass along the edge 26 of the glass sheet 25. As the temperature of the edge 26 and strip 28 rise, transient tensile stresses occur generally at A1 and transient compressive stresses occur generally at inboard locations A2 along the temperature line in FIG. 2A. Notably, tensile and compressive stresses may vary along the edge 26 and along the strip 28 depending on thermodynamic and physical properties of the glass and depending on particular process parameters. The radiant heaters 24 increase the temperature of the glass sheet 25 at the edge 26 and along strip 28. In the FIG. 2A, location A1 (which is on the edge surface 26) has a temperature T1 of about 400° C. to 440° C. above the temperature T4, while location A2 (which is located near a center of the strip 28 inboard on the glass sheet slightly away from the edge 26 such as about 10 mm, for example) has a temperature T2 of slightly higher (such as 25° C. to 40° C.) than temperature T1. The location A3 (which is inboard of location A2 such as about an additional 10 mm and is located where internal residual stress is balanced on an inboard side of the strip 28) has a temperature T3 close to but slightly below temperature T1. The location A4 (which is located still further inboard of the strip 28 and inboard of the location A3) has a temperature T4. As illustrated, the radiant heaters 24 cause a temperature gradient between locations A4 to A2 that rises relatively smoothly but at a rapidly increasing rate from T4 to T2. However, the temperature peaks at location A2 and then decreases slightly from location A2 (i.e., temperature T2) to location A1 (i.e., temperature T1 at the edge 26).

The difference between T1 and T4 is optimally about 400° C., but it is noted that this optimal temperature may vary significantly depending on material properties and process parameters. The temperature difference between T1 and T2 can vary, but in the present example is estimated to be about 25° C. to about 40° C. The residual stress (represented by the gray area in FIG. 2A) is compressive stress at the inboard location A4, and decreases until it is essentially zero or “balanced” at location A3 (on the inboard side of the strip 28). At location A3, the internal residual stress is reversed and becomes tensile stress at location A2 on a center of the strip 28. At location A at the edge 26, the residual stress is again essentially zero or balanced. Notably, the location A4 may not experience compressive stresses as there will be some amount of buckling in the sheet. A key feature of the present invention is to generate thermal tension during transient heating along the edge via thermal compression below the edge. The other transient stresses are merely “balancing” stresses generated based on glass size and shape.

In step 21, the strip 28 inboard of the edge 26 is heated to provide an increased thermal tensioning along the edge 26 by using a focused second heat source, such as burners 27. The burners 27 generate a larger thermal gradient below the edge just prior to edge finishing. This gradient will cause the temperature at the edge to be lower than the temperature in this narrow area just below the edge. The burner 27 is applied at an incident angle to the glass. This incident angle as well as the distance between the burner and the glass is varied to change the area as well as the temperature of the localized hot spot that is created along the edge. This process forces the edge into transient tension relative to the hot spot below it. Controlling the temperature magnitude and location (via burner control) also helps maintain glass alignment during application of the laser beam, such as by helping keep the glass sheet in plane.

Specifically, the thermal tensioning is accomplished by heating the specific location A2 on the strip 28 by angled/focused burners 27, while continuing to heat the edge 26 and strip 28 of the LCD glass sheet 25 (FIGS. 3 and 3A) between the opposing radiant heaters 24. As illustrated, the focused burners 27 are variably controlled by a controller to increase the temperature of the glass sheet 25 around the location A2, with an increase in temperature at the peak (i.e., location A2) being about an additional 25° C. to 85° C. Thus, the illustrated temperature differential between edge location A1 and strip location A2 is about 50° C. to about 125° C., and is preferably about 100° C., resulting in a substantial increase in thermal tension along the edge. The location A2 is located near a center of the strip 28 inboard on the glass sheet slightly away from the edge 26 such as about 10 mm for example. This range of temperature differential creates optimal thermal tensioning prior to the laser operation. The location A3 (which is inboard of location A2 such as about an additional 10 mm and is located where internal stress is balanced on an inboard side of the strip 28) has a temperature T3 close to but slightly below temperature T1. Notably, the temperature T3 as shown in FIG. 3A may rise slightly from that shown in FIG. 2A, due to thermodynamic effects and heat transfer within and around the glass sheet 25 as the sheet moves between the heaters 24, past burners 27 and on to the laser treatment station. The transient stress (see FIG. 3A) is similar to that shown in FIG. 2A, though magnified at location A2.

The step 22 (FIGS. 4, 4A and 4B) includes finishing the edge 26 of the glass 25 using an elliptically shaped laser beam 29 having a “hat-shaped” beam profile. Notably, the “hat” of the beam is slightly greater than a thickness of the glass 25, allowing some variation of a relative position of the beam 29 without the beam 29 missing the edges 26a and 26b of the glass sheet 25. The edge 26 is a cut edge, and includes relatively sharp top and bottom corners 26A and 26B. The beam 29 is elongated and is positioned orthogonal to the edge of the sheet of glass. The elliptical shape of the beam is preferred because it provides for a higher process speed. The beam shape is obtained through reflective and refractive optics that are commercially available, such as can be obtained from II-IV company, or Laser Research Optics company. A “D” mode profile is modified to provide a top hat structure (FIG. 4). This profile uses a nearly constant peak power over a beam width and hence reduces variation in edge rounding as a function of glass to beam alignment. This results in uniform edge rounding and decreased breakage during transience.

The glass is moved under the laser beam and produces a round edge when sufficient flux is applied to the edge. The “mushrooming” of the sheet from the plane of the glass sheet is minimal (i.e., less than 0.5 μm). The radius of curvature can be adjusted by varying the process parameters such as laser power applied and residence time of the laser. The result of using a laser edge finishing treatment can produce a high localized stress in the first 1 mm along the glass edge (e.g., greater than 8000 psi). This is undesirable because it can result in fracture during or post processing and also can prevent the cutting of the substrate into desired sizes. However, by using the present thermal tensioning, this edge stress can be reduced to about 1000 psi, as discussed below. It is noted that the radius of the curvature can be adjusted by varying the laser process parameters, such as laser power applied and residence time of the laser.

The annealing step 23 (FIG. 5 and 5A) includes using burners 31 powered by natural gas or hydrogen as fuel. Oxygen and/or air are used as oxidation sources in the localized heat treatment process. The burners 31 are applied to the edge 26 such that the temperature of the edge 26 is above the annealing point of the glass. The burners 31 are moved along the length of the glass sheet 25 during this application to minimize the variation in temperature across the flame front as well as to provide the glass sheet 25 a chance to heat up and cool down (relax) during this heat treating process. The temperature of the glass sheet 25 is maintained above annealing by controlling the number of passes that the burners 31 make over the edge 26 and by controlling the mass flow rate of gas and air as a function of time. The burners 31 are applied to the glass sheet 25 at an incident angle to localize heating and eliminate buoyancy driven flow effects on the flame front. The burners 31 are adjustably moved along as well as perpendicular to the motion of the glass sheet 25. Also, the gas and air input are varied to adjustably control output energy/glass temperature. This process makes it possible to achieve edges that have residual tensile stress below 3000 psi, and more preferably below 1000 psi, and even as low as 600 psi, based on readings using a commercially available device such as a DIAS-1600 unit from StrainOptics Inc using standard operating procedures. Notably, edge impact tests and bend tests along the edge produce improved results consistent with the above readings of low residual edge stress. It is noted that residual edge stress of below 3000 psi may be important since it allows further glass cutting and processing without formation of unacceptable defects and glass damage.

As shown in FIG. 6 and 6A, the edge of the glass sheet (as finished using the present thermal tensioning process) has a clean rounded edge. It is noted that the edge can be made to have a continuous arcuate (semi-cylindrical) shape (as shown) extending from a front face surface to a rear face surface of the glass. However, it is contemplated that the edge of the glass sheet (as finished using the present thermal tensioning process) can also be made to have two arcuate corners connected by a flat, where laser beams are used to treat the corners while leaving an untreated (or lightly treated) flat therebetween. It is also contemplated that an edge can be treated to be asymmetric, parabolic or other shapes.

It is noted that the thermal tensioning process of the present procedure results in “stress cancellation.” The term “stress cancellation” need not be defined in detail in this disclosure, but it is noted herein to assist those skilled in the art to understand the dynamics of the present edge-finishing process.

While the invention has been described in conjunction with specific exemplary embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

1. A method of thermal edge finishing for finishing brittle sheet, such as glass sheet and ceramic sheet, having at least one edge, comprising steps of:
heating at least one edge of the sheet including a strip of material that extends along the edge but inboard thereof;
increasing a temperature of the strip relative to a temperature at the edge;
treating the edge with a thermal heat source such as a laser beam to round and finish the edge; and
annealing the edge and the strip of material to reduce stresses generated during edge finishing.

2. The method defined in claim 1, wherein the step of increasing a temperature includes providing a focused heat source oriented to heat the strip to a higher temperature than the edge.

3. The method defined in claim 2, wherein the step of increasing the temperature includes providing the focused heat source as comprising a burner having a flame focused on the strip and spaced from the edge.

4. The method defined in claim 2, wherein the step of increasing the temperature includes providing the burner as comprising a variable heat source.

5. The method defined in claim 2, wherein the step of increasing the temperature includes orienting the focused heat source at an angle to a plane defined by the sheet.

6. The method defined in claim 1, wherein the step of heating includes providing opposing side heaters positioned to heat the at least one edge and the strip.

7. The method defined in claim 6, wherein the heating step includes providing the side heaters as comprising radiant heaters.

8. The method defined in claim 1, wherein the step of annealing includes providing an annealing heat source comprising a multi-pass burner.

9. The method defined in claim 8, wherein the step of annealing includes controlling a flow of the burner and controlling a relative position of the burner to the sheet based on time.

10. The method defined in claim 1, including providing a controller for heating, the controlling being programmed to control a temperature of the strip during the step of annealing.

11. The method defined in claim 1, including providing a device adapted to generate a laser beam with a pattern that is elongated in a direction parallel the edge of the sheet, and wherein the step of treating the edge includes directing the laser beam onto the edge.

12. The method defined in claim 11, wherein the step of annealing includes controlling a cool down time of the edge by changing on the heat source a mass flow rate of gas and air over time.

13. The method defined in claim 11, wherein the step of annealing includes controlling a cool down time of the edge by changing a distance of the heat from the edge over time.

14. The method defined in claim 1, wherein the steps of heating, increasing temperature, treating the edge, and annealing reduce stress along the at least one edge to below about 3000 psi.

15. The method defined in claim 14, wherein the reduced residual stress of the at least one edge is below about 1000 psi.

16. The method defined in claim 1, wherein the step of annealing includes annealing multiple ones of the edges of the sheet a sufficient time and temperature to simultaneously anneal the multiple edges.

17. The method defined in claim 1, wherein the step of treating the edge with a thermal heat source includes treating the edge with a laser beam.

18. The method defined in claim 17, wherein the sheet defines a plane, and wherein the step of treating the edge includes keeping the edge in-plane within 50% of a thickness of the sheet.

19. A method of thermal edge finishing for finishing an edge of brittle sheet, such as glass sheet and ceramic sheet, comprising steps of:
thermally tensioning the sheet along the edge by preheating the edge and also causing a temperature of an area located inboard from the edge to be higher than a temperature of the edge; and
laser-finishing the edge to a non-sharp shape.

20. The method defined in claim 19, including controlling the temperature of the inboard area and the edge after laser-finishing the edge to reduce edge-finishing-induced stress.

21. An apparatus for thermally finishing sheet such as glass sheet and ceramic sheet having an edge, comprising:
a first heat source for heating the edge of the sheet including heating a strip of material that extends along the edge but inboard thereof;
a second heat source for increasing a temperature of the strip relative to a temperature at the edge;
a thermal heat source such as a laser device configured to produce a laser beam adapted to round and finish the edge; and
a third heat source for annealing the edge and the strip of material to reduce stresses generated during edge finishing by the thermal heat source.

22. The apparatus of claim 21, including a support for the sheet, at least one of the support and the third heat source being adjustable toward and away from the other.

23. The apparatus of claim 21, including a controller operably connected to and controlling the laser device and the third heat source.

24. The apparatus of claim 23, wherein the third heat source is adjustable for varying a distance from the glass, and the controller controls the distance.

25. The apparatus of claim 23, wherein the third heat source is adjustable for varying the quantity of heat provided, and the controller controls the quantity of heat.

26. The apparatus of claim 23, wherein the thermal heat source comprises a laser device.
